(19) United States
(12) Patent Application Publication
(10) Pub. No.: US 2013/0307760 A1
(43) Pub. Date: Nov. 21, 2013

(54) ORGANIC LIGHT EMITTING DISPLAY

(71) Applicant: Hyung-Soo Kim, Yongin-si (KR)

(72) Inventor: Hyung-Soo Kim, Yongin-si (KR)

(21) Appl. No.: 13/608,688

(22) Filed: Sep. 10, 2012

(30) Foreign Application Priority Data
May 16, 2012 (KR) 10-2012-0051983

(51) Int. Cl. G09G 3/32

(52) U.S. Cl. 345/83; 345/82

(57) ABSTRACT

An organic light emitting display includes a plurality of scan lines, a plurality of data lines crossing the scan lines, a plurality of sub pixels coupled to the scan lines and the data lines, and an auxiliary scan line coupling at least two of the scan lines coupled to respective ones of the sub pixels of a pixel.

### CROSS-REFERENCE TO RELATED APPLICATION

This application claims priority to and the benefit of Korean Patent Application No. 10-2012-0051983, filed on May 16, 2012, in the Korean Intellectual Property Office, the entire content of which is incorporated herein by reference.

### BACKGROUND

1. Field

Embodiments of the present invention relate to an organic light emitting display.

2. Description of the Related Art

In general, flat panel displays (FPDs) such as liquid crystal displays (LCDs) and organic light emitting displays are manufactured by semiconductor processes. In the semiconductor processes, lines that constitute thin film transistors (TFTs), capacitors, and circuits are formed in patterns having minute line width and distance, and the patterns are arranged in a multi-layer structure with an interlayer insulating layer interposed therebetween.

Because the patterns are arranged at minute intervals, and because the interlayer insulating layer is thin, when defects or contamination, such as particles, are generated during a photolithography process and an etching process of forming the patterns, the lines that cross each other with an interlayer insulating layer interposed therebetween, or adjacent lines, may be electrically shorted.

The defect caused by an electrical short may be detected by a line test and a position test during a test process, which may be the final process of the manufacturing processes, and may be corrected by a repair process. The defect may be removed by the repair process to reduce manufacturing cost.

Since the width and/or the thickness of power supply lines is larger than that of common lines that constitute a circuit, the power supply lines are easily shorted to the other adjacent or crossing lines. Because the thick power supply lines are to be cut by laser, the repair process for repairing the defect is difficult. Furthermore, power is not supplied to the cut off power supply lines and, although power is supplied through relatively thin auxiliary power supply lines, partial circuits or elements may not normally operate during this process.

### SUMMARY

Accordingly, embodiments of the present invention provide an organic light emitting display capable of being easily repaired.

Embodiments of the present invention also provide an organic light emitting display capable of reducing or minimizing damage caused by repairing.

To achieve the foregoing and/or other aspects of embodiments of the present invention, there is provided an organic light emitting display including a plurality of scan lines, a plurality of data lines crossing the scan lines, a plurality of sub pixels coupled to the scan lines and the data lines, and an auxiliary scan line coupling at least two of the scan lines coupled to respective ones of the sub pixels of a pixel.

The auxiliary scan line may be located between the pixel and an adjacent pixel.

The organic light emitting display may further include power supply lines crossing the plurality of scan lines.

The organic light emitting display may further include a plurality of auxiliary scan lines including the auxiliary scan line, and the power supply line may be located between adjacent ones of the auxiliary scan lines.

The power supply lines may be thicker than the scan lines.

The sub pixels of the pixel may include a red sub pixel, a green sub pixel, and a blue sub pixel.

The auxiliary scan line may be coupled to two of the scan lines that are respectively coupled to two of the red sub pixel, the green sub pixel, and the blue sub pixel.

The auxiliary scan line may be coupled to three of the scan lines that are respectively coupled to the red sub pixel, the green sub pixel, and the blue sub pixel.

The organic light emitting display may further include a plurality of auxiliary scan lines including the auxiliary scan line, and the auxiliary scan line may be coupled to three of the scan lines that are respectively coupled to the red sub pixel, the green sub pixel, and the blue sub pixel of the pixel, and another one of the auxiliary scan lines may be coupled to two of the three scan lines that are respectively coupled to a red sub pixel, a green sub pixel, and a blue sub pixel of a second pixel.

The pixel may be adjacent the second pixel.

The same scan signal may be provided to ones of the scan lines that are coupled to respective ones of the sub pixels of the pixel.

According to embodiments of the present invention, at least two scan lines among the plurality of scan lines coupled to the plurality of sub pixels that constitute one pixel are coupled to each other by the auxiliary scan line. When the scan lines are shorted to the power supply lines, because repairing may be performed by cutting off the scan lines having smaller width and thickness without cutting off the power supply, which has relatively large width and thickness, the repair process may be improved. In addition, since the scan signal may be rerouted via the auxiliary scan line, all of the sub pixels may normally operate after the repair process, thereby avoiding damage caused by repair.

### BRIEF DESCRIPTION OF THE DRAWINGS

The accompanying drawings, together with the specification, illustrate exemplary embodiments of the present invention, and, together with the description, serve to explain aspects of embodiments of the present invention.

FIG. 1 is a block diagram illustrating an organic light emitting display according to a first embodiment of the present invention;

FIG. 2 is a block diagram illustrating an organic light emitting display according to a second embodiment of the present invention;

FIG. 3 is a block diagram illustrating an organic light emitting display according to a third embodiment of the present invention; and

FIGS. 4 and 5 are schematic diagrams illustrating a repair method according to an embodiment of the present invention.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or may be indirectly coupled to the second element via one or more other elements. Further, some of the elements that are not essential to the complete understanding of the invention are omitted for clarity. Also, like reference numerals refer to like elements throughout.

Hereinafter, the exemplary embodiments of the present invention will be described in detail with reference to the accompanying drawings. The following embodiments are provided to have those skilled in the art sufficiently understand the present invention, and may be modified in various forms. The scope of the present invention is not limited to the following embodiments.

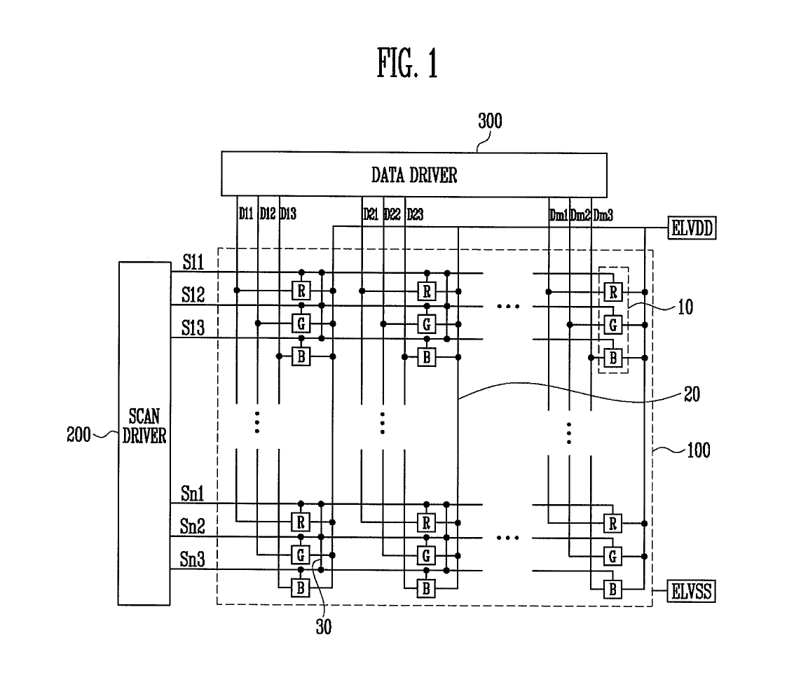

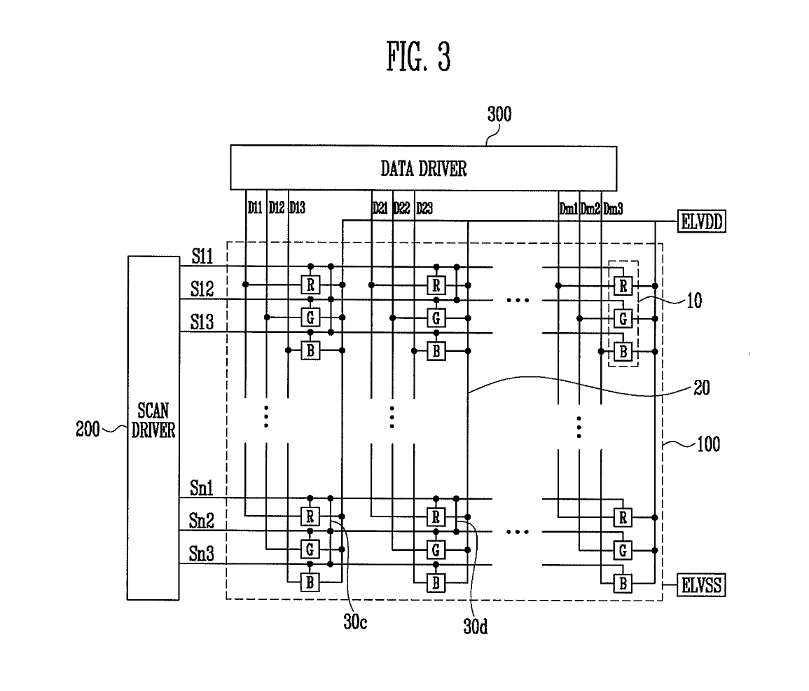

FIGS. 1 and 3 are block diagrams illustrating organic light emitting displays according to the embodiments of the present invention.

Referring to FIGS. 1 to 3, the organic light emitting display includes a pixel unit 100 in which a plurality of pixels 10 are arranged in a matrix among a plurality of scan lines S11 to Sn3 and a plurality of data lines D11 to Dm3, and also includes a scan driver 200 coupled to the scan lines S11 to Sn3, and a data driver 300 coupled to the data lines D11 to Dm3.

The plurality of scan lines S11 to Sn3 are arranged to extend in one direction, for example, in a row direction. The plurality of data lines D11 to Dm3 are arranged to extend in a direction that crosses the scan lines S11 to Sn3, for example, in a column direction.

Each of the plurality of pixels 10 includes a plurality of sub pixels, for example, a red sub pixel R, a green sub pixel G, and a blue sub pixel B. Each of the sub pixels R, G, and B includes an anode electrode, an organic light emitting layer, and a cathode electrode, and is coupled to a power supply voltage ELVDD and a ground voltage ELVSS. For example, the anode electrode is coupled to the power supply voltage ELVDD, and the cathode electrode is coupled to the ground voltage ELVSS.

The power supply voltage ELVDD is supplied to the respective sub pixels R, G, and B through power supply lines 20. In the pixel unit 100, the power supply lines 20 may be extended along the data lines of the columns of the pixels 10, or may be extended along the columns and rows of the pixels 10 in a mesh structure.

FIGS. 1 to 3 illustrate a pixel array in which a red sub pixel R, a green sub pixel G, and a blue sub pixel B, which constitute one pixel 10, are repetitively arranged in a column direction, the red sub pixel R, the green sub pixel G, and the blue sub pixel B of each column m are coupled to the data lines Dm1, Dm2, and Dm3, respectively, and the red sub pixel R, the green sub pixel G, and the blue sub pixel B of each row n are coupled to the scan lines Sn1, Sn2, and Sn3, respectively (n and m being natural numbers).

In the pixel array, at least two scan lines among the plurality of scan lines Sn1 to Sn3 coupled to the red sub pixel R, the green sub pixel G, and the blue sub pixel B of a pixel 10 are coupled to each other by auxiliary scan lines 30. When the auxiliary scan lines 30 are formed in the same layers as the scan lines, or in different layers, the auxiliary scan lines 30 may be coupled to the scan lines through a contact hole formed in the interlayer insulating layer.

Referring to FIG. 1, a first embodiment of the present invention has a structure in which the auxiliary scan lines 30 are commonly coupled to the scan lines Sn1 to Sn3 coupled to the red sub pixel R, the green sub pixel G, and the blue sub pixel B of a pixel 10, and the auxiliary scan lines 30 are arranged between pixels 10 that are adjacent to each other in a row direction.

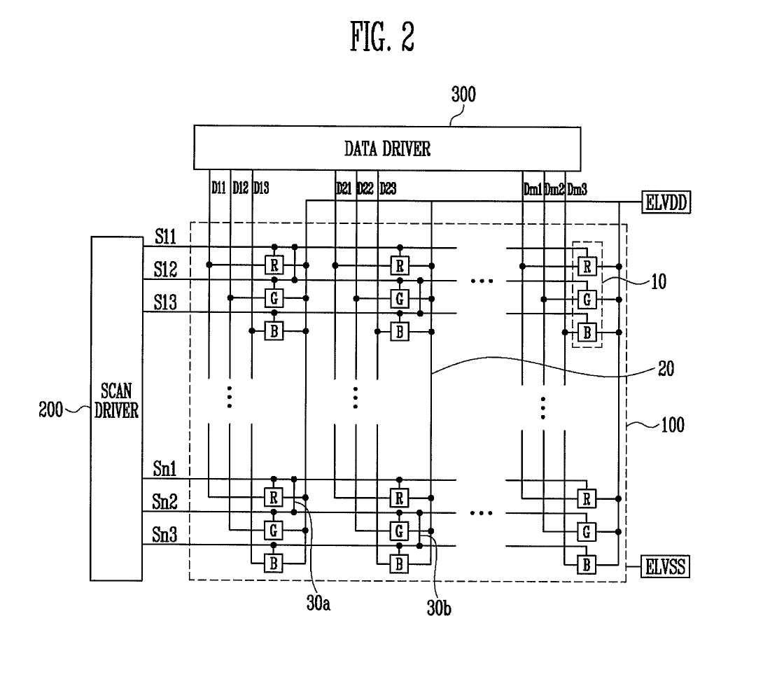

Referring to FIG. 2, a second embodiment of the present invention has a structure in which the auxiliary scan lines 30 are commonly coupled to the scan lines Sn1 and Sn2, or to the scan lines Sn2 and Sn3, and are coupled to two sub pixels among the red sub pixel R, the green sub pixel G, and the blue sub pixel B of one pixel 10, and the auxiliary scan lines 30 are arranged between the pixels 10 adjacent to each other in a row direction such that the auxiliary scan line 30a commonly coupled to the scan lines Sn1 and Sn2 coupled to the red sub pixel R and the green sub pixel G, and the auxiliary scan line 30b commonly coupled to the scan lines Sn2 and Sn3 coupled to the green sub pixel G and the blue sub pixel B, are alternately arranged (e.g., in the row direction).

Referring to FIG. 3, a third embodiment of the present invention has a structure in which the first embodiment and the second embodiment are combined with each other. The auxiliary scan line 30c commonly coupled to the scan lines Sn1 to Sn3, which are coupled to the red sub pixel R, the green sub pixel G, and the blue sub pixel B, and the auxiliary scan line 30d commonly coupled to the scan lines Sn1 and Sn2, which are coupled to the red sub pixel R and the green sub pixel G, are alternately arranged (e.g., in a direction from left to right).

In the organic light emitting display having the above structure, the power supply line 20 is provided between two adjacent auxiliary scan lines 30, and is formed to be thicker (for example, no less than 100 μm) than the scan lines S11 to Sn3 or the data lines S11 to Sn3.

Since the power supply lines 20 cross the scan lines S11 to Sn3, the power supply lines 20 may be shorted to the scan lines S11 to Sn3 when a defect is generated in the interlayer insulating layer during manufacturing processes. The defect caused by the short may be detected through a line test and a position test in a test process that may be the final process of the manufacturing processes, and may be removed by a repair process.

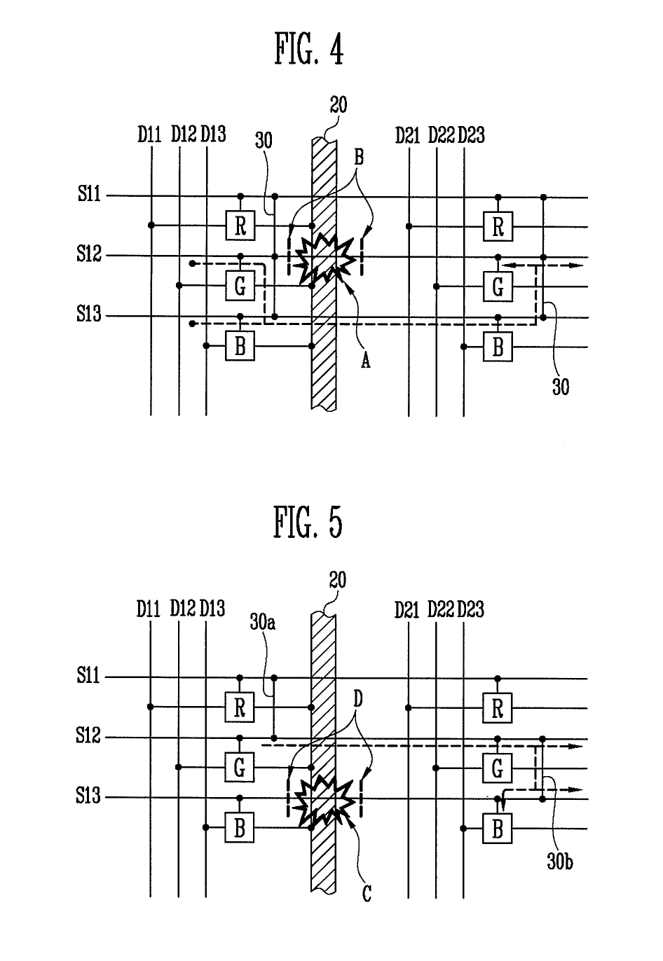

FIG. 4 is a schematic diagram illustrating a repair method when a short is generated in the structure of the first embodiment of the present invention.

For example, when the scan line S12 and the power supply line 20, which cross each other, are shorted to each other (part A) in an area between two pixels 10 coupled to the scan lines S11 to S13, the scan line S12 on both sides of the power supply line 20 is cut off (part B) using laser (e.g., to isolate the short).

Because the pixels 10 coupled to each other in a row direction are commonly coupled to the scan lines S11 to S13, and because the same scan signal is supplied to the scan lines S11 to S13, the scan signal supplied to the scan line S12 or to the scan line S13 may be supplied to the green sub pixel G provided after the cut off part B, that is, provided to the right of the cut off part B, through the auxiliary scan line 30.

FIG. 5 is a schematic diagram illustrating a repair method when a short is generated in the structure of the second embodiment of the present invention.

For example, when the scan line S13 and the power supply line 20 that cross each other are shorted to each other (part C) between two pixels 10 coupled to the scan lines S11 to S13, the scan line S13 on both sides of the power supply line 20 is cut off (part D) using a laser (e.g., to isolate the short).

Because the pixels 10 adjacent to each other in a row direction are commonly coupled to the scan lines S11 to S13, and because the same scan signal is supplied to the scan lines S11 to S13, the scan signal supplied to the scan line S12 may be supplied to the blue sub pixel B beyond the cut off part D. That is, the scan signal is provided to the blue sub pixel B to the right of the cut off part D through the auxiliary scan line 30b.

As described above, according to embodiments of the present invention, because the power supply lines 20 having large width and/or thickness are not cut off, and because the scan line S12 having small width and/or thickness is cut off, the repair process is made easier. In addition, when it is assumed that the auxiliary scan lines 30 do not exist, since the scan signal is not transmitted to the green sub pixel G in FIG. 4, or to the blue sub pixel B in FIG. 5, which are respectively coupled to scan lines S12 and S13, after the cut off part (B or D), the lines in the corresponding row become dark. However, according to embodiments of the present invention, since all of the sub pixels R, G, and B may normally operate after the repair process, damage caused by repair may be avoided.

While embodiments of the present invention have been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display comprising:
a plurality of scan lines;
a plurality of data lines crossing the scan lines;
a plurality of sub pixels coupled to the scan lines and the data lines; and
an auxiliary scan line coupling at least two of the scan lines coupled to respective ones of the sub pixels of a pixel.

2. The organic light emitting display as claimed in claim 1, wherein the auxiliary scan line is located between the pixel and an adjacent pixel.

3. The organic light emitting display as claimed in claim 1, further comprising power supply lines crossing the plurality of scan lines.

4. The organic light emitting display as claimed in claim 3, further comprising a plurality of auxiliary scan lines comprising the auxiliary scan line, wherein the power supply line is located between adjacent ones of the auxiliary scan lines.

5. The organic light emitting display as claimed in claim 3, wherein the power supply lines are thicker than the scan lines.

6. The organic light emitting display as claimed in claim 1, wherein the sub pixels of the pixel comprise a red sub pixel, a green sub pixel, and a blue sub pixel.

7. The organic light emitting display as claimed in claim 6, wherein the auxiliary scan line is coupled to two of the scan lines that are respectively coupled to two of the red sub pixel, the green sub pixel, and the blue sub pixel.

8. The organic light emitting display as claimed in claim 6, wherein the auxiliary scan line is coupled to three of the scan lines that are respectively coupled to the red sub pixel, the green sub pixel, and the blue sub pixel.

9. The organic light emitting display as claimed in claim 6, further comprising a plurality of auxiliary scan lines comprising the auxiliary scan line,
wherein the auxiliary scan line is coupled to three of the scan lines that are respectively coupled to the red sub pixel, the green sub pixel, and the blue sub pixel of the pixel, and
wherein another one of the auxiliary scan lines is coupled to two of the three scan lines that are respectively coupled to a red sub pixel, a green sub pixel, and a blue sub pixel of a second pixel.

10. The organic light emitting display as claimed in claim 9, wherein the pixel is adjacent the second pixel.

11. The organic light emitting display as claimed in claim 1, wherein the same scan signal is provided to ones of the scan lines that are coupled to respective ones of the sub pixels of the pixel.
